(19) United States
(12) Patent Application Publication
(10) Pub. No.: US 2010/0209766 A1
(43) Pub. Date: Aug. 19, 2010

(54) SECONDARY BATTERY

(75) Inventor: Wan-Mook LIM, Suwon-si (KR)

Correspondence Address: STEIN MCEWEN, LLP, 1400 EYE STREET, NW, SUITE 300, WASHINGTON, DC, 20005, US

(73) Assignee: Samsung SDI Co., Ltd., Suwon-si (KR)

(21) Appl. No.: 12/704,649

(22) Filed: Feb. 12, 2010

(30) Foreign Application Priority Data
Feb. 16, 2009 (KR) 10-2009-0012526

(51) Int. Cl. H01M 2/08

(52) U.S. Cl. 429/174

(57) ABSTRACT

A secondary battery includes an electrode assembly including a positive electrode plate, a negative electrode plate, and a separator interposed between the two electrode plates, a can housing the electrode assembly and a cap assembly sealing the can. Further, the secondary battery includes an electrode assembly including a positive electrode plate, a negative electrode plate and a separator interposed between the two electrode plates, a can housing the electrode assembly and a cap assembly sealing the can. An outer diameter of the electrode assembly is in the range from more than 0.997 to less than 1.014 times an inner diameter of the can during discharge of the secondary battery and/or is in the range from more than 1.017 to less than 1.034 times the inner diameter of the can during charge of the secondary battery.

### CROSS-REFERENCE TO RELATED APPLICATION

This application claims the benefit of Korean Patent Application No. 2009-12526, filed Feb. 16, 2009 in the Korean Intellectual Property Office, the disclosure of which is incorporated herein by reference.

### BACKGROUND OF THE INVENTION

1. Field of the Invention

Aspects of the present invention relate to a secondary battery, and more particularly, to a secondary battery which can prevent an electrode tab electrically connected to a positive or negative electrode plate of an electrode assembly from being detached due to external vibration, without degrading a life span characteristic.

2. Description of the Related Art

In recent times, compact, slim and light-weight portable electric/electronic devices (including cellular phones, notebook computers and camcorders) are being actively developed and produced. These devices have a secondary battery pack that can be operated even in places in which a power source is not provided. Examples of the secondary battery pack include nickel-cadmium (Ni—Cd), nickel-metal hydride (Ni-MH) and lithium (Li) batteries, which are generally rechargeable secondary batteries, and thus have economical advantages.

Among them, the Li secondary batteries are widely used in the portable electric/electronic devices because they have a three times higher operating voltage and a higher energy density per unit weight than that of the Ni—Cd and Ni-MH batteries. The Li secondary batteries can be classified by the type of electrolyte used into a lithium ion battery using a liquid electrolyte and a lithium polymer battery using a polymer electrolyte. The Li secondary batteries can also be categorized by the shape of the secondary battery into cylindrical, prismatic and pouch type batteries.

The secondary battery generally includes an electrode assembly, a can housing the electrode assembly and an electrolyte which allows migration of lithium ions in the electrode assembly, and a cap assembly sealing the can. Here, the electrode assembly includes positive and negative electrode plates and a separator. The positive electrode plate has a positive electrode collector to which a positive electrode active material is applied and a positive electrode tab electrically connected to a side of the positive electrode assembly. The negative electrode plate has a negative electrode collector to which a negative electrode active material is applied and a negative electrode tab electrically connected to a side of the negative electrode collector. A separator is interposed between the both electrode plates.

For a cylindrical secondary battery, the cap assembly is a bit different from other types of the Li secondary battery. Generally the cap assembly includes a cap-up electrically connected to an external terminal and also connected to a top opening of the can to thereby seal the can, and a safety vent. The safety vent is electrically connected to the positive or negative electrode plate and is deformed or broken to discharge gas outside when an inner pressure is higher than a certain level due to the gas generated from the electrode assembly. The cap assembly may further include a current interrupt device (CID) disposed on the safety vent and which is deformed or broken by the safety vent to interrupt an electrical connection between the electrode assembly and an external terminal when the safety vent is deformed or broken due to the gas generated in the electrode assembly. Alternately, a sub-plate and cap-down may be interposed between the safety vent and the electrode assembly to interrupt an electrical connection between the safety vent and the electrode assembly due to deformation or breakage of the safety vent.

Here, the cap assembly may further include a positive temperature coefficient (PTC) thermistor disposed between the CID and the cap-up or between the safety vent and the cap-up in order to prevent overcurrent between the electrode assembly and the external terminal.

In the conventional secondary battery, an outer diameter of an electrode assembly is designed smaller than an inner diameter of a can to prevent damage to the outermost layer of the electrode assembly during a process of housing the electrode assembly in the can, and to easily house the electrode assembly. For this reason, the electrode assembly is moved by continuous impact or vibration from outside, and electrode tabs such as positive and negative electrode tabs electrically connected to positive and negative electrode plates of the electrode assembly, respectively, are detached, resulting in an increase in inner resistance in the secondary battery.

If the outer diameter of the electrode assembly is increased to solve this problem, the electrode assembly can be damaged during the process of housing the electrode assembly in the can, and if the electrode assembly expands during the charge or discharge of the secondary battery, the electrode assembly can be deformed, resulting in degradation of an electrode assembly and a life span characteristic of the secondary battery.

### SUMMARY OF THE INVENTION

Aspects of the present invention provide a secondary battery, which prevents deformation of an electrode assembly during charge or discharge of the secondary battery, and minimizes detachment of an electrode tab due to external impact or vibration by designing an outer diameter of the electrode assembly and an inner diameter of a can in a predetermined ratio.

According to an exemplary embodiment of the present invention, a secondary battery includes: an electrode assembly including a positive electrode plate, a negative electrode plate, and a separator interposed between the two electrode plates; a can housing the electrode assembly; and a cap assembly sealing the can. Here, an outer diameter of the electrode assembly is designed in the range from more than 0.997 to less than 1.014 times an inner diameter of the can during discharge of the secondary battery.

According to another exemplary embodiment of the present invention, a secondary battery includes: an electrode assembly including a positive electrode plate, a negative electrode plate and a separator interposed between the two electrode plates; a can housing the electrode assembly; and a cap assembly sealing the can. Here, an outer diameter of the electrode assembly is designed in the range from more than 1.017 to less than 1.034 times an inner diameter of the can during charge of the secondary battery.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is an exploded perspective view of a secondary battery according to an exemplary embodiment of the present invention; and

FIG. 2 is a cross-sectional view of the secondary battery according to an exemplary embodiment of the secondary battery.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

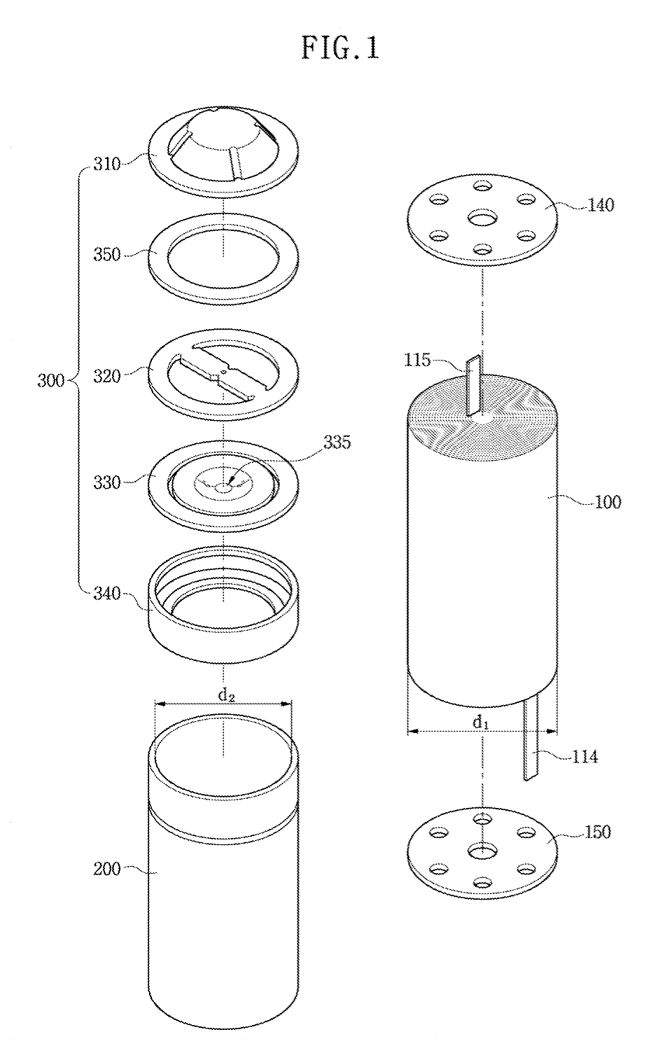

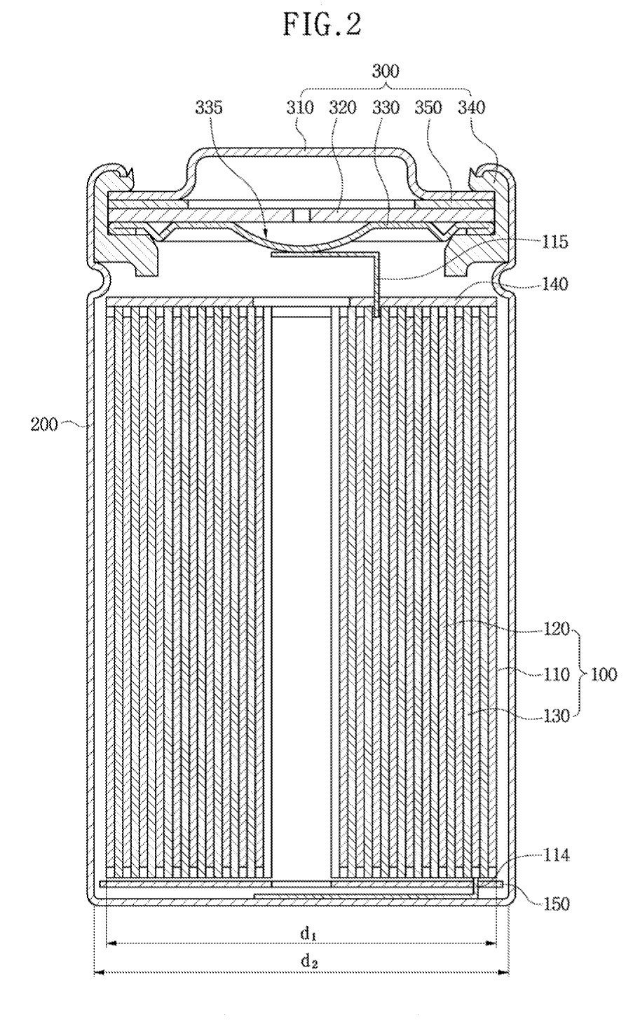

FIG. 1 is an exploded perspective view of a secondary battery according to an exemplary embodiment of the present invention, and FIG. 2 is a cross-sectional view of the secondary battery according to an exemplary embodiment of the secondary battery. Referring to FIGS. 1 and 2, the secondary battery includes an electrode assembly 100, a can 200 housing the electrode assembly 100 and an electrolyte (not shown), and a cap assembly 300 sealing the can 200.

The electrode assembly 100 includes positive and negative electrode plates 110,120 and a separator 130. The positive electrode plate 110 has a positive electrode collector (not shown) to which a positive electrode active material (not shown) is applied and a positive electrode tab 115 electrically connected to a side of the positive electrode collector. The negative electrode plate 120 has a negative electrode collector (not shown) to which a negative electrode active material (not shown) is applied and a negative electrode tab 114 electrically connected to a side of the negative electrode collector. The separator 130 is interposed between the positive electrode plate 110 and the negative electrode plate 120. As shown, the electrode assembly 100 further includes an upper insulating plate 140 disposed on an upper surface of the electrode assembly 100 to prevent vertical movement of the electrode assembly 100 and an unnecessary electrical connection between the electrode assembly 100 and the cap assembly 300, and a lower insulating plate 150 disposed on a lower surface of the electrode assembly 100 to prevent an unnecessary electrical connection between the electrode assembly 100 and the can 200. However, it is understood that the upper insulating plate 140 and/or the lower insulating plate 150 need not be used in all aspects.

While, in the exemplary embodiment, the positive electrode tab 115 of the electrode assembly 100 projects upwardly from the electrode assembly 100 to be electrically connected to the cap assembly 300, and the negative electrode tab 114 of the electrode assembly 100 projects downwardly from the electrode assembly 100 to be electrically connected to the can 200, the positive and negative electrode tabs 115 and 114 may project in the opposite directions to each other or in the same direction.

Examples of the positive electrode active material may include lithium-containing transition metal oxides or lithium chalcogenide compounds including LiCoO₂, LiNiO₂, LiMnO₂, LiMn₂O₄ and LiNi_{1-x-y}CoₓM_{y}O₂ (wherein, 0≦x≦1, 0≦y≦1, 0≦x+y≦1, and M is a metal, e.g., Al, Sr, Mg or La). Examples of the negative electrode active material may include carbon materials (such as crystalline carbon, amorphous carbon, a carbon complex and a carbon fiber) a lithium metal, and a lithium alloy.

The positive or negative electrode collector may be formed of one selected from the group consisting of stainless steel, nickel, copper, aluminum and an alloy thereof. The positive electrode collector may be formed of aluminum or an aluminum alloy, and the negative electrode collector may be formed of copper or a copper alloy to maximize efficiency.

The separator 130 is interposed between the positive electrode plate 110 and the negative electrode plate 120 to prevent an electrical short circuit between the both electrode plates 110 and 120, and allow migration of lithium ions. The separator 130 may be a polyolefin-based polymer layer formed of polyethylene (PE) or polypropylene (PP) or a multilayer thereof.

The can 200 may be formed of a metallic material, and have a top opening to house the electrode assembly 100 and the electrolyte. Here, the can 200 may be formed of a metallic material such as aluminum, an aluminum alloy or stainless steel, which is light and flexible, and electrically connected to the negative electrode tab of the electrode assembly 100 to serve as an electrode terminal.

To prevent damage to the electrode assembly 100 due to the process of housing the electrode assembly 100 in the can 200 and to easily house the electrode assembly 100, an inner diameter d2 of the can 200 is preferably larger than an outer diameter d1 of the electrode assembly 100. Here, the inner diameter d2 of the can 200 is the smallest diameter of the can 200, and can be measured by subtracting a thickness of the can 200 from the lowest of outer diameters of the can 200 measured by a length measurer such as vernier calipers. The outer diameter d1 of the electrode assembly 100 is the greatest diameter of the electrode assembly 100, and can be measured by the length measurer such as the vernier calipers. Generally, the highest of the outer diameters d1 is at a diameter including one or all of the positive and negative electrode tabs 115 and 114 of the electrode assembly 100.

The electrolyte allows the lithium ions generated by an electrochemical reaction between the positive and negative electrode plates 110 and 120 of the electrode assembly 100 to be migrated during charge or discharge of the secondary battery. The electrolyte may be a non-aqueous organic electrolyte formed of a compound of a lithium salt and a high-purity organic solvent, or a polymer using a polymer electrolyte. However, it is understood that the electrolyte can other types of solid, liquid, and gel electrolytes.

The cap assembly 300 includes a cap-up 310 coupled to the top opening of the can 200 to thereby seal the can 200 and is electrically connected to an external terminal, a safety vent 330 deformed or broken by an inner pressure, a current interrupt device (CID) 320 disposed on the safety vent 330 and broken by the safety vent 330 being deformed or broken due to an inner pressure to interrupt an electrical connection between the electrode assembly 100 and an external terminal, and a gasket 340 insulating the cap assembly 300 from the can 200 and more stably sealing the can 200. While not required in all aspects, the shown cap assembly 300 further includes a positive temperature coefficient (PTC) thermistor 350 disposed in a region where the CID 320 is in contact with the cap-up 310. Alternately, the PTC thermistor 350 can be in a region where the safety vent 330 is in contact with the CID 320 to prevent application of overvoltage and overcurrent to the electrode assembly 100.

While, in the exemplary embodiment, the cap assembly 300 includes the cap-up 310, the safety vent 330 and the CID 320, it may include the cap-up 310, the safety vent 330, a sub-plate (not shown) interposed between the safety vent 330 and the electrode assembly 100 to interrupt an electrical connection between the safety vent 330 and the electrode assembly 100 by deformation and breakage of the safety vent 330, and a cap-down (not shown).

When an inner pressure is higher than a certain level due to the gas generated from the electrode assembly 100, the safety vent 330 is deformed or broken to thereby discharge the gas. A portion 335 thereof projects toward the electrode assembly 100. Here, the certain region 335 of the safety vent 330 projects, toward the electrode assembly 100, and is electrically connected to the positive or negative electrode plate 110 or 120 of the electrode assembly 100 via the electrode tab 115 electrically connected to the positive or negative tab of the electrode assembly 100.

Table 1 shows a vibration test result and a life span characteristic according to a ratio of an outer diameter d1 of the electrode assembly 100 to an inner diameter d2 of the can 200 (d1/d2) when the secondary battery is discharged. The outer diameter d1 of the electrode assembly 100 is measured after being inserted into the can 200 and thus reflects a size when the electrode assembly 100 is discharged after being housed in the can 200. Here, the vibration test is conducted using an amplitude of the secondary battery of 0.8 mm according to the UL International Standards, and a frequency of 10 to 55 Hz is applied for 90 to 100 minutes to vibrate the secondary battery. The vibration test result is dependant on whether an inner resistance is increased or not. The life span characteristic was a comparison of the actual life span as compared to the theoretical maximum life span.

Further, in the discharged state, the outer diameter d1 of the electrode assembly 100 is the highest of values obtained by measuring a length of the electrode assembly 100 using a length measurer, such as vernier calipers. The inner diameter d2 of the can 200 is a value obtained by subtracting a thickness of the can 200 from the lowest of values obtained by measuring an outer diameter of the can 200 using the length measurer, such as the vernier calipers. The outer diameter d1 of the electrode assembly 100 was at its highest when the diameter d1 included one or all of the positive and negative electrode tabs 115 and 114 of the electrode assembly 100.

TABLE 1

| Ratio (d1/d2) | 0.997 | 1 | 1.011 | 1.014 |
|---|---|---|---|---|
| Vibration Test | NG | OK | OK | OK |
| Result | | | | |
| Life Span | 93% | 91% | 92% | 63% |
| Characteristic | | | | |

Referring to Table 1, in the discharged state, when the ratio of the outer diameter d1 of the electrode assembly 100 to the inner diameter d2 of the can 200 (d1/d2) is 0.997 or less, the vibration test results in NG (i.e., no good). When the ratio is 1.014 or more, the life span characteristic of the secondary battery is significantly decreased.

Accordingly, in the discharged state, the outer diameter d1 of the electrode assembly 100 is designed to be in the range from more than 0.997 to less than 1.014 times, and preferably 1 to 1.011 times, the inner diameter d2 of the can 200. Thus, the increase of the inner resistance of the secondary battery due to continuous impact or vibration applied from outside can be prevented without degrading the life span characteristic of the secondary battery due to the outer diameter d1 being substantially equal to and/or greater than the inner diameter d2 of the can 200.

Table 2 shows a vibration test result and a life span characteristic according to a ratio of an outer diameter d1 of the electrode assembly 100 to an inner diameter d2 of the can 200 (d1/d2) when the secondary battery is charged. The outer diameter d1 of the electrode assembly 100 is measured prior to insertion into the can 200 and thus reflects a size when the electrode assembly 100 is charged prior to being housed in the can 200.

TABLE 2

| Ratio (d1/d2) | 1.017 | 1.021 | 1.031 | 1.034 |
|---|---|---|---|---|
| Vibration Test | NG | OK | OK | OK |
| Result | | | | |
| Life Span | 93% | 91% | 92% | 63% |
| Characteristic | | | | |

Referring to Table 2, in the charged state, when the ratio of the outer diameter d1 of the electrode assembly 100 to the inner diameter d2 of the can 200 (d1/d2) is 1.017 or less, the vibration test results in NG. When the ratio is 1.034 or more, the life span characteristic of the secondary battery is significantly decreased.

Accordingly, in the charged state, the outer diameter d1 of the electrode assembly 100 is designed in the range from more than 1.017 to less than 1.034 times, and preferably 1.021 to 1.031 times, the inner diameter d2 of the can 200. Thus, increase of the inner resistance of the secondary battery due to continuous impact or vibration applied from outside can be prevented without degrading the life span characteristic of the secondary battery.

As a result, in the secondary battery according to aspects of the present invention, when discharged, the outer diameter of the electrode assembly 100 is designed in the range from more than 0.997 to less than 1.014 times, and preferably, 1 to 1.011 times, the inner diameter d2 of the can 200. However, when charged, the outer diameter d1 of the electrode assembly 100 is designed in the range from more than 1.017 to less than 1.034 times, and more preferably, 1.021 to 1.031 times, the inner diameter d2 of the can 200. Thus, an increase of the inner resistance of the secondary battery due to vibration applied from outside can be prevented without degrading the life span characteristic of the secondary battery due to the outer diameter d1 being substantially equal to and/or greater than the inner diameter d2 of the can 200.

Further, in the secondary battery, when discharged, the outer diameter of the electrode assembly is designed in the range from more than 0.997 to less than 1.014 times, and when charged, the outer diameter d1 of the electrode assembly 100 is designed in the range from more than 1.017 to less than 1.034 times, and more preferably, 1.021 to 1.031 times, the inner diameter d2 of the can 200. Thus, when the outer diameter of the electrode assembly satisfies the two conditions described above, the increase of the inner resistance of the secondary battery due to vibration applied from outside can be further prevented without degrading the life span characteristic of the secondary battery.

In a secondary battery according to aspects of the present invention, when discharged, an outer diameter d1 of an electrode assembly 100 is designed in the range from more than 0.997 to less than 1.014 times an inner diameter d2 of a can 200. However, when charged, an outer diameter d1 of an electrode assembly 100 is designed in the range from more than 1.017 to less than 1.034 times the inner diameter d2 of the can 200. Thus, when the outer diameter d1 of the electrode assembly 100 satisfies both conditions described above, an increase of an inner resistance of the secondary battery due to impact or vibration applied from outside can be prevented without degrading a life span characteristic.

Although a few embodiments of the present invention have been shown and described, it would be appreciated by those skilled in the art that changes may be made in these embodiments, without departing from the principles and spirit of the invention, the scope of which is defined in the claims and their equivalents.

What is claimed is:

1. A secondary battery, comprising:
an electrode assembly including a positive electrode plate, a negative electrode plate, and a separator interposed between the positive and negative electrode plates;
a can housing the electrode assembly; and
a cap assembly sealing the can,
wherein, an outer diameter of the electrode assembly is in a range from more than 0.997 to less than 1.014 times an inner diameter of the can when the secondary battery is discharged.

2. The secondary battery according to claim 1, wherein the outer diameter of the electrode assembly is in a range from 1 to 1.011 times the inner diameter of the can when the secondary battery is discharged.

3. The secondary battery according to claim 1, wherein the outer diameter of the electrode assembly is a greatest of the outer diameters of the electrode assembly measured by a length measurer.

4. The secondary battery according to claim 1, wherein the inner diameter of the can is a value obtained by subtracting a thickness of the can from the lowest of the outer diameters of the can measured by a length measurer.

5. The secondary battery according to claim 1, wherein the outer diameter of the electrode assembly is a diameter including one or all of a positive electrode tab electrically connected to the positive electrode plate and a negative electrode tab electrically connected to the negative electrode plate.

6. The secondary battery according to claim 1, wherein, prior to insertion in the can a difference between the outer diameter of the electrode assembly and the inner diameter of the can is 0.2 mm or less when the secondary battery is discharged.

7. The secondary battery according to claim 1, wherein, prior to insertion in the can, the outer diameter of the electrode assembly is in the range from more than 1.017 to less than 1.034 times the inner diameter of the can when the secondary battery is charged.

8. The secondary battery according to claim 7, wherein, prior to insertion in the can, the outer diameter of the electrode assembly is in the range from 1.021 to 1.031 times the inner diameter of the can when the secondary battery is charged.

9. The secondary battery according to claim 1, wherein the outer diameter of the electrode assembly is smaller than the inner diameter of the can before the electrode assembly is housed in the can.

10. A secondary battery, comprising:
an electrode assembly including a positive electrode plate, a negative electrode plate and a separator interposed between the positive and negative electrode plates;
a can housing the electrode assembly; and
a cap assembly sealing the can,
wherein, an outer diameter of the electrode assembly is in a range from more than 1.017 to less than 1.034 times an inner diameter of the can when the secondary battery is charged.

11. The secondary battery according to claim 10, wherein, prior to insertion in the can, the outer diameter of the electrode assembly is in a range from 1.021 to 1.031 times the inner diameter of the can when the secondary battery is charged.

12. The secondary battery according to claim 10, wherein the outer diameter of the electrode assembly is a greatest of the outer diameters of the electrode assembly measured by a length measurer.

13. The secondary battery according to claim 10, wherein the inner diameter of the can is a value obtained by subtracting a thickness of the can from the lowest of the outer diameters of the can measured by a length measurer.

14. The secondary battery according to claim 10, wherein the outer diameter of the electrode assembly is a diameter including one or all of a positive electrode tab electrically connected to the positive electrode plate and a negative electrode tab electrically connected to the negative electrode plate.

15. The secondary battery according to claim 10, wherein, prior to insertion in the can, a difference between the outer diameter of the electrode assembly and the inner diameter of the can is 0.2 mm or less when the secondary battery is discharged.

16. The secondary battery according to claim 10, wherein the outer diameter of the electrode assembly is smaller than the inner diameter of the can before the electrode assembly is housed in the can.
